(19) United States
(12) Patent Application Publication
(10) Pub. No.: US 2010/0079916 A1
(43) Pub. Date: Apr. 1, 2010

(54) LOW POWER VOICE COIL MOTOR WITH A GUIDING MAGNET SHELL

(75) Inventor: Shih-Chuan Lee, Hsinchu City (TW)

Correspondence Address: COVENANT IP CONSULTING CO., P.O. BOX 34-306 TAIPEI CITY, TAIPEI, 10499, TW

(73) Assignee: VASSTEK INTERNATIONAL CORP., Hsinchu City (TW)

(21) Appl. No.: 12/533,209

(22) Filed: Jul. 31, 2009

(30) Foreign Application Priority Data
Oct. 1, 2008 (TW) 097137888

(51) Int. Cl. G11B 21/08

(52) U.S. Cl. 360/264.9; G9B/21.012

(57) ABSTRACT

A low power voice coil motor (VCM) with a guiding magnet shell comprises a magnetic device, a lens carrier, a base, a plurality of guide posts, an electromagnetic driving apparatus and a shell enclosing the lens carrier, the magnetic device and the electromagnetic driving apparatus. The shell and the magnetic device are arranged with a distance within a predetermined range and the attractive force between the magnetic device and the shell in lateral direction induces a shift of the lens carrier for added the friction force between the plurality of guide posts and walls of a plurality of holes. The added friction force is larger than a gravitational force from a total weight of the magnetic device, the lens carrier and a lens set held by the lens carrier, and/or an upward attractive force of the shell on the magnetic device, so the lens set can be fixed at a position even if power is turned off.

### BACKGROUND OF THE INVENTION

1. Field of the Invention

The present invention relates to a voice coil motor, and more particularly, to a voice coil motor with low power capability by a guiding magnet shell.

2. Description of the Prior Art

In order to perform a more accurate position control for a set of lenses or an access arm of a hard disk drive, a voice coil motor (VCM) is adopted to move the set of lenses or the access arm of the hard disk drive. The structure of a VCM is primarily a coil placed within a magnetic path including a permanent magnet.

In an optical system employing a VCM, an interaction propelling force between the coil and the permanent magnet according to Fleming's left-hand rule to move a carrier physically connected to the permanent magnet when a current flows through the coil; at the same time, a set of lenses which is attached to the carrier is moved correspondingly, so as to achieve optical zoom and focus functionalities. Based on applying a specific current value, an accurate control for optical zooming and focusing can be easily achieved.

Since an auto-focusing (AF) optical system employing the VCM comprises a metal flexible plate, the interaction propelling force between the coil and the permanent magnet is against the flexible force from the metal flexible plate in accordance with Hooke's law so as to move the carrier into a specific location by continuously applying the current to the coil. However, the current is consumed continuously depend on the maintaining time in order to maintaining the location of carrier so that it can not satisfy low power design requirement for portable devices.

To solve the problem, the Taiwan Patent No. I287906 “power of the voice coil motor design” provides a solution. FIG. 1 schematically illustrates a cross-sectional diagram of a VCM 1 of the prior art. As shown in FIG. 1, the voice coil motor comprises the guide posts 422 and 421 and electromagnetic drive mechanism (mainly constructed by the coil 41) on the base 43. After the lens carrier 45 is equipped with the base 43, the guide posts 422 and 421 fixed on the base 43 contacts against the opening curved surface 51 of the lens carrier 45 and passes through the through-hole 52 of the lens carrier 45 thereof respectively and the coil 41 is placed within the air gap between the bottom yoke 445, the non-ring magnets 441, 442, and non-ring yoke 443, 444. The detail descriptions are skipped herein.

In the low power design as shown in FIG. 1, by mainly utilizing leakage magnetic fluxes of a magnetic device, including the bottom yoke 445, non-ring magnets 441, 442 especially and non-ring yokes 443, 444, to attract the guide posts 422 or 421, friction force between the lens carrier 45 and the guide posts 422, 421 is caused. The add friction force is sufficient to resist a gravitational force from a total weight of the lens carrier 45 and a lens set 46 to fix the lens set 46 at a specific position without continuously applying the current to the coil 41, especially after positioning has been finished, to achieve low power.

However, the lens carrier 45 with the opening curved surface 51 and the through-hole 52 is too complicated for fabricating the lens carrier 45. When assembling the lens carrier 45 and the base 43, the guide posts 422 must contact against the opening curved surface 51 and the guide posts 421 must pass through the through-hole 52 so that the lens carrier 45 is directional in assembly. The guide posts 422 and 421 respectively must be installed on the base 43 via the opening curved surface 51 and the through-hole 52 so that there is position offset between the guide posts 422, 421 and the opening curved surface 51 and the through-hole 52 to cause to interfere with the operation of the VCM.

### SUMMARY OF THE INVENTION

The present invention is directed to a low power voice coil motor (VCM) with a guiding magnet shell, wherein attractive force in lateral direction between a magnetic device and a shell of the VCM causes friction force between a lens carrier and a plurality of guide posts. The added friction force is sufficient to maintain the lens carrier and other devices thereon at a specific position without applying the current to a coil. Furthermore, both the design and the assembling process of the lens carrier are simplified.

One embodiment of a VCM according to the present invention consists essentially of a magnetic device, a lens carrier physically connected to the magnetic device, a base, a plurality of guide posts fixed on the base, an electromagnetic driving apparatus and a shell. In general, when current is applied to the coil, the coil interacts with the magnetic field of the magnetic device and causes a propelling force which moves the lens carrier straightly along the plurality of guide posts.

Furthermore, optical axis deviation under the movement of the lens carrier is improved by providing attractive force between the lens carrier and the plurality of guide posts to ensure close contact between them and to force the lens carrier into moving straightly.

To achieve low power, the shell is arranged at a distance within a predetermined range from the magnetic device, so that the magnetic device and the shell may attract each other laterally inducing a shift of the lens carrier and added the friction force between the plurality of guide posts and walls of a plurality of holes. The added friction force is larger than the gravitational force from a total weight of the magnetic device, the lens carrier and a lens set held by the lens carrier, and/or an upward attractive force of the shell on the magnetic device to maintain the lens set at a fixed position adjusted using the coil even if power applied to the coil is turned off.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional voice coil motor (VCM).

FIG. 2A and FIG. 2B are schematic diagrams of an exemplary voice coil motor illustrating some aspects of the present invention.

FIG. 3A and FIG. 3B are schematic diagrams of an exemplary voice coil motor illustrating other aspects of the present invention.

### DETAILED DESCRIPTION

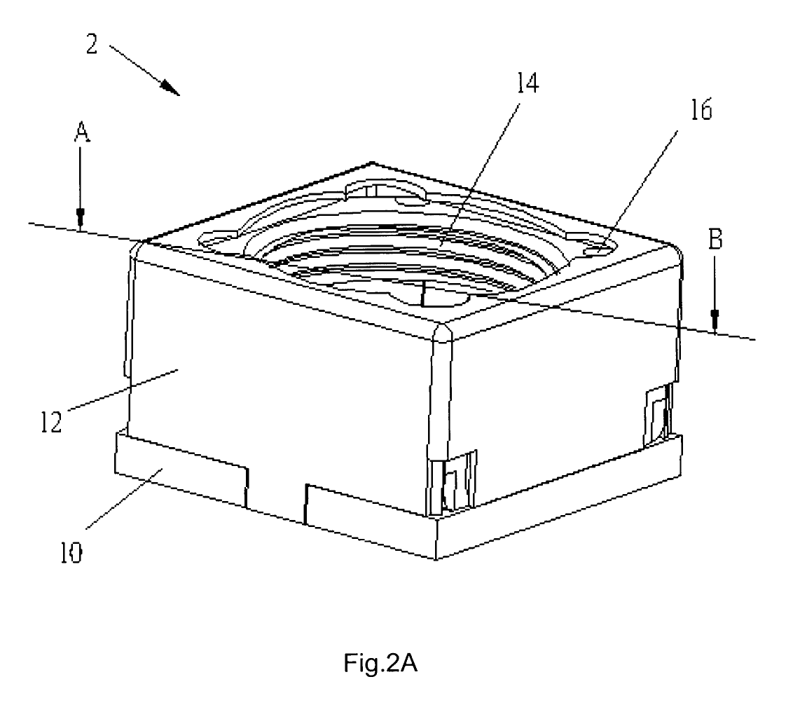

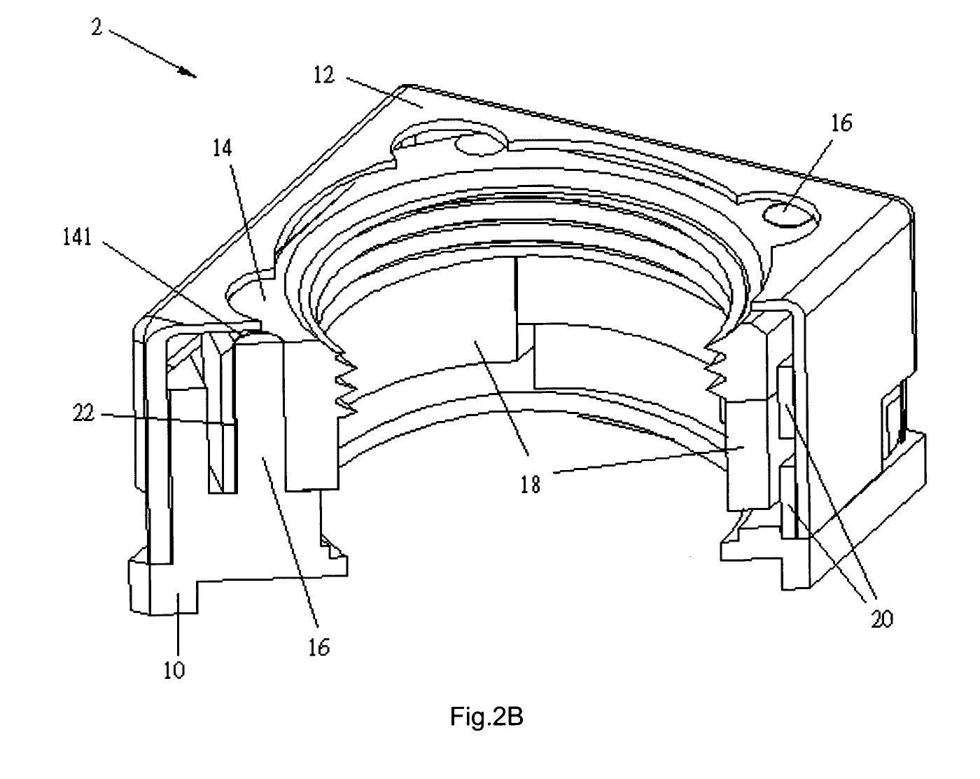

Please refer to FIG. 2A and FIG. 2B in correspondence with the following description. FIG. 2A and FIG. 2B are schematic diagrams illustrating a voice coil motor (VCM) according to some aspects of the present invention. As illustrated in FIG. 2A, a VCM 2 comprises a base 10, a shell 12 disposed on the base 10, a lens carrier 14 enclosed by the shell 12 and a plurality of guide posts 16 passing through the lens carrier 14. FIG.2A may be cross sectioned along line AB to be observed as a three dimensional structure as depicted in FIG. 2B.

As illustrated in FIG. 2B, the VCM 2, except for above-mentioned components, further comprises the plurality of guide posts 16 on the base 10, an electromagnetic driving apparatus (mainly constructed by a coil 20), and a magnetic device 18 physically connected with the lens carrier 14.

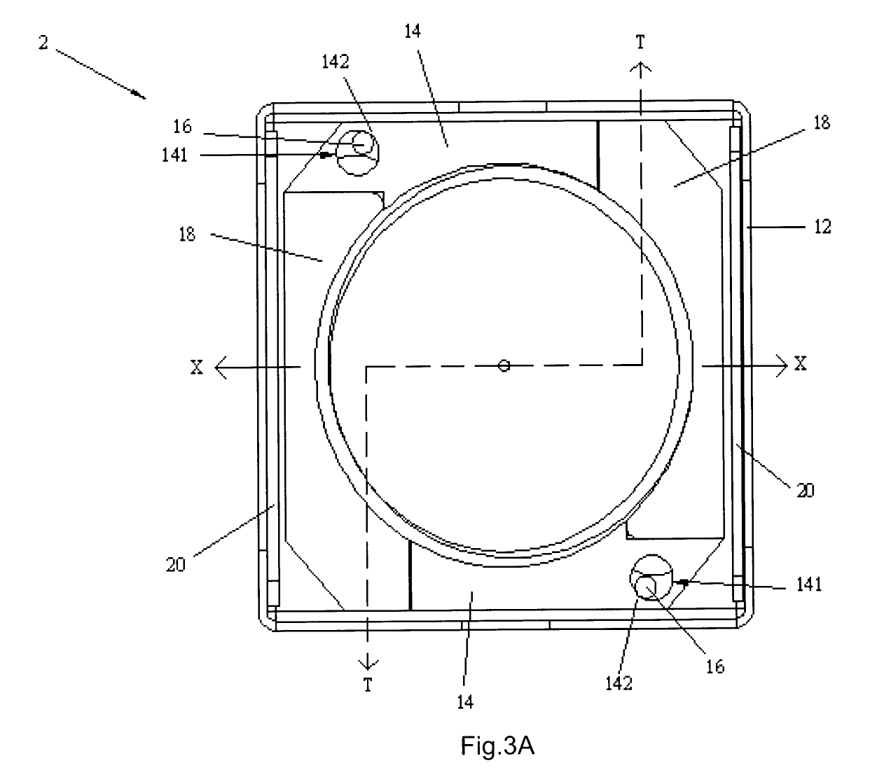

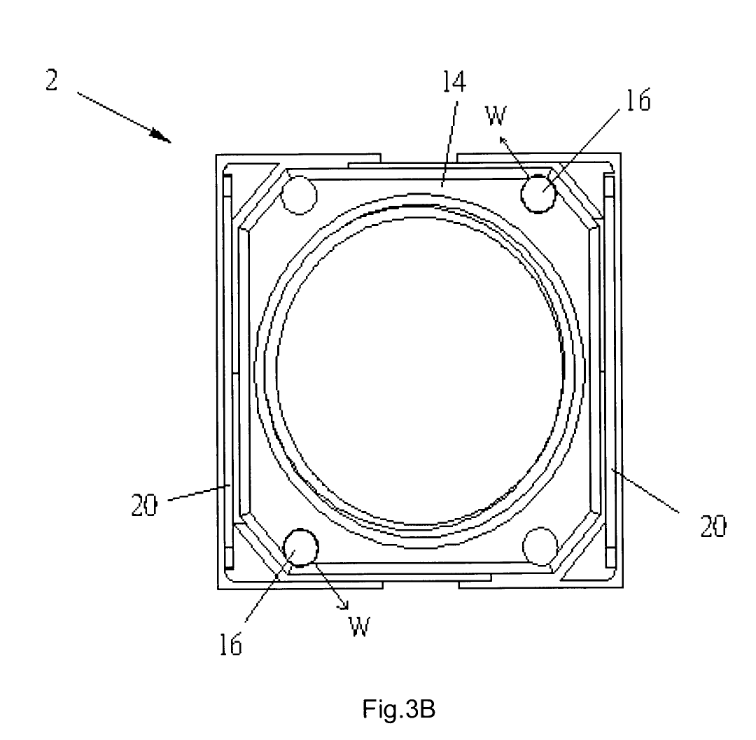

Briefly, the magnetic device 18 attracts the shell 12 in lateral direction, denoted as lateral attractive force T as shown in FIG. 3A, so as to the lateral attractive force T causes breakout friction force between the lens carrier 14 and the plurality of guide posts 16. The added breakout friction force is sufficient to maintain the lens carrier 14 and other devices at a specific position without applying the current to the coil 20 continuously as the conventional art. Besides, both the design and assembling process of the lens carrier 14 are simplified according to some aspects of the present invention. It is emphatically noted that the shell 12 is made of a paramagnetic material so that the magnetic device 18 and the shell 12 attract each other. Similarly with the actuation mechanism of the VCM 2 is the same as that of the VCM 1 of the prior art using a magnetic force to move a lens carrier 14, so the detail descriptions are skipped herein based on the low power design of the VCM 2 of the present invention is mainly according to the low power design of the VCM 1 of the prior art.

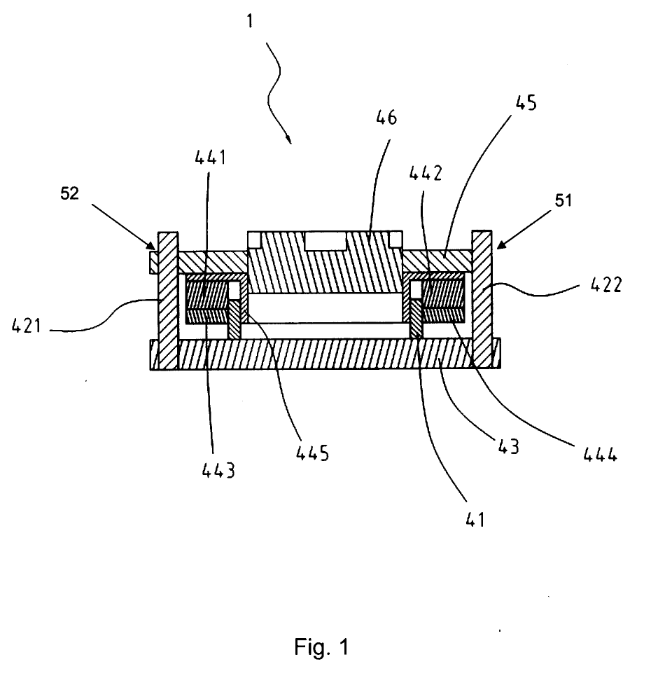

Both the VCM 1 of the prior art illustrated in FIG. 1 and the VCM 2 of the present invention maintain the lens carriers 45, 14 at a specific position, even when power being supplied to the coil 20 is turned off. The attractive force is between the magnetic device and guide posts 422, 421 in VCM 1 design of the prior art and the attractive force is between the magnetic device 18 and the shell 12 in the VCM 2 design of the present invention. On the other hand, added the friction force between the lens carrier 45 and guide posts 422, 421 in VCM 1 design of the prior art, is different from the added friction force between the lens carrier 14 and the plurality of guide posts 16 in the VCM 2 design of the present invention. Based on the above different, the present design relaxes the need for extra concern to the relationship between the lens carrier 14 and the plurality of guide posts 16, so that directionless holes 141 may be used for the lens carrier 14 and the cost of assembly and manufacture may be reduced.

For assembling the lens carrier 14 and the base 10, a plurality of holes 141 of the lens carrier 14 are aligned with and slipped on the plurality of guide posts 16 on the base 10, and then the shell 12 is placed over the lens carrier 14 and is fixed on the skirts of the base 10. In one embodiment, the magnetic device 18 and the plurality of guide posts 16 do not need to attract each other, so that both the base 10 and the plurality of guide posts 16 can be made of a plastic material and can be made in one piece to reduce the assembling and manufacturing cost (because it is not necessary to insert and fix guide posts 422, 421 on the base 43 as for the VCM 1 of the prior art). Accordingly, the cost of manufacturing the base 10 and the plurality of guide posts 16 are reduced and, the position offset between the base 10 and the plurality of guide posts 16 and in turn the interference issue of the lens carrier 14 during the operation of the VCM 2 is avoided.

It is emphatically noted that the material of the plurality guide posts 16 may still be made of metal to be attracted by the magnetic device 18. Therefore, in determining the distance between the shell 12 and the magnetic device 18, the attractive force between the magnetic device 18 and the plurality of guide posts 16 should be taken into consideration.

During the zooming operation, a coil 20 of an electromagnetic driving apparatus is powered. In such situation, the interaction propelling force, between the coil 20 and main magnetic fluxes of the magnetic device 18, is raised to resists the added breakout friction force between the lens carrier 14 and the plurality of guide posts 16 until the propelling force can move the lens carrier 14 straightly along the plurality of guide posts 16. For low power purpose, after focusing and zooming, the power being supplied to the coil 20 of the electromagnetic driving apparatus should be turned off, but the lens carrier 14 and other devices thereon must remain at the specific position. For example, the lens carrier 14 and other devices may remain at the top position after focusing and zooming for picturing a macro subject, or the lens carrier 14 and other devices may remain at the lowest position after focusing and zooming for picturing a highly distant subject.

FIG. 3A and FIG. 3B are schematic diagrams illustrating other aspects of the VCM according to one embodiment of the present invention. FIG. 3A and FIG. 3B depict bottom-views of the VCM 2 after removing the base 10 for the purpose of illustration. The magnetic device 18 is omitted in FIG. 3B compared with FIG. 3A. As shown in FIG. 3A, the distance between the shell 12 and the magnetic device 18 is arranged within a predetermined range so that lateral attractive force T is caused between the magnetic device 18, physically connected with the lens carrier 14, and the shell 12, with forces in X directions cancel each other out, and then forces W is caused in normal directions, as shown in FIG. 3B, for shifting the lens carrier 14 such that added friction force between the plurality of guide posts 16 and walls of the plurality of holes 141 (especially at friction points 142) is added. The added friction force is larger than the gravitational force from the total weight of the magnetic device 18, the lens carrier 14, and a lens set (not shown) held by the lens carrier 14 and/or an upward attractive force of the shell 12 on the magnetic device 18. Therefore, the lens set can be fixed at the final position from positioning the lens set using the coil 20 after finishing positioning the lens set using the coil 20 even if power applied to the coil 20 is turned off.

Furthermore, the low power design according to the present invention may be applied to a multi-lens set. For moving two VCMs 2 on the same optical path, the length of the plurality of guide posts 16 must be long enough for the two VCMs 2 to move along the plurality of guide posts 16 within a certain range to increase the magnification. Barrier parts (not shown) are disposed at about the middle of the plurality of guide posts 16 to confine each lens set to move within the range.

Those skilled in the art will readily observe that numerous modifications and alterations of the device and method may be made while retaining the teachings of the invention.

What is claimed is:

1. A low power voice coil motor with a guiding magnet shell consisting essentially of a magnetic device, a lens carrier physically connected with said magnetic device, a base, a plurality of guide posts fixed on said base, an electromagnetic driving apparatus constructed by a coil and said shell enclosing said lens carrier, said magnetic device and said electromagnetic driving apparatus, wherein said plurality of guide posts pass through a plurality of holes on said lens carrier respectively, characterized in that
said shell is made of a paramagnetic material and that
said shell is arranged at a distance within a predetermined range from said magnetic device physically connected with said lens carrier, so that said magnetic device attracts said shell in lateral direction inducing a shift of said lens carrier and added friction force between said plurality of guide posts and walls of said plurality of holes, wherein said added friction force is larger than a gravitational force from a total weight of said magnetic device, said lens carrier and a lens set held by said lens carrier, and/or an upward attractive force of said shell on said magnetic device to maintain said lens set at a fixed position after finishing positioning said lens set using said coil even if power applied to said coil is turned off.

2. A low power voice coil motor with a guiding magnet shell according to claim 1, wherein said base and said plurality of guide posts are made in one piece.

3. A low power voice coil motor with a guiding magnet shell according to claim 1, wherein said lens carrier is moved straightly along the direction of said plurality of guide posts by an interaction between main magnetic fluxes provided by said magnetic device and said coil of said electromagnetic driving apparatus when said coil is powered.

4. A low power voice coil motor with a guiding magnet shell according to claim 1, wherein said base is symmetrically equipped with at least two said plurality of guide posts.

5. A low power voice coil motor with a guiding magnet shell according to claim 1, wherein both said base and said plurality of guide posts are made of a plastic material.
